(19) United States
(12) Patent Application Publication
(10) Pub. No.: US 2025/0123236 A1
(43) Pub. Date: Apr. 17, 2025

(54) MULTI-ELECTRODE, HIGH-THROUGHPUT ELECTROCHEMICAL CELL

(71) Applicant: SAMSUNG ELECTRONICS CO., LTD., Suwon-si (KR)

(72) Inventor: Michael Jong Hoon CHON, Medford, MA (US)

(73) Assignee: SAMSUNG ELECTRONICS CO., LTD., Suwon-si (KR)

(21) Appl. No.: 18/812,746

(22) Filed: Aug. 22, 2024

Related U.S. Application Data
(60) Provisional application No. 63/543,864, filed on Oct. 12, 2023.

(51) Int. Cl. G01N 27/413; G01N 27/30; G01N 27/406; H01M 10/42

(52) U.S. Cl. CPC G01N 27/413; G01N 27/301; G01N 27/4065; H01M 10/4207; H01M 10/4285

(57) ABSTRACT

An electrochemical cell includes at least two first electrodes, a separator layer, a common second electrode, an ionically conductive electrolyte, a base, and a lid, wherein the common second electrode is embedded in the base and the at least two first electrodes are embedded in the lid, the separator layer is ionically conductive and separates the at least two first electrodes from the common second electrode, the ionically conductive electrolyte creates an ionic pathway between the at least two working electrodes and the reference electrode, the base and lid are sealed against each other with an O-ring, each first electrode is sealed against the lid by an O-ring, at least one first electrode is electrically independent from all other first electrodes, and the lid has at least one hole, wherein the at least one hole can have at least one first electrode that is part of at least one cell.

### CROSS-REFERENCE TO RELATED APPLICATION

This application is based on and claims priority from U.S. Provisional Application No. 63/543,864 filed on Oct. 12, 2023 in the U.S. Patent and Trademark Office, the disclosure of which is incorporated herein by reference in its entirety.

### BACKGROUND

### 1. Field

Embodiments of the present disclosure relate to a multi-electrode, high-throughput electrochemical cell, and more particularly relate to a high throughput, multi-channel electrochemical battery (half) cell for materials screening.

### 2. Description of the Related Art

Cell testing is a component of battery research to validate battery materials and processes. The process of preparing and assembling coin cells may be relatively labor intensive and prone to user-influenced variations. The success rate of a given batch of cells may vary strongly with an individual's competency, typically between 50-75%. However, battery performance is a statistics-based science that may involve large data sets to attain high fidelity and confidence in experimental conditions. This creates a natural tension between the cost and quality of a given dataset for testing battery materials.

One approach for a high-throughput electrochemical cell uses voltage control to test cells that are electrically coupled, but this approach exposes materials to high current rates that often lead to premature degradation. As a result, the capacity and rate of degradation of these cells fall below the industry standard for cell testing.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

The disclosure provides a multi-electrode, high-throughput electrochemical cell, and more particularly a high throughput, multi-channel electrochemical battery (half) cell for materials screening, according to embodiments.

As indicated above, the process of preparing and assembling coin cells for cell testing may be relatively labor intensive and prone to user-influenced variations, which can result in poor yield. By addressing some key sources of poor yield, aspects of some embodiments may reduce the materials and labor cost per successful test.

Specific issues to be addressed include the time required to assemble coin cells, the low yield, the material cost of coin cells, and the high labor cost. In regard to the issue of low yield in particular, only about three fifths of cells that are built cycle successfully, and accidental shorting during crimping and handling can occur. As to the issue of the material cost, typical slurry preparation methods such as typical cathode slurry preparation methods use 1-10 g active material per batch with a significant amount of wasted material.

An object of the present disclosure is to provide a cell which can allow relatively high throughput testing of battery and other electrochemical materials by parallelizing the preparation and testing of candidate materials. By streamlining the process of preparing cells, embodiments of the present disclosure can reduce the time per cell to prepare, assemble and test. As a result, more materials can be screened to obtain statistically significant data sets for a given experimental condition.

Another object of the present disclosure is to develop a method to dispense slurry such as cathode slurry using only 10-50 mg active material.

Thus, the present disclosure provides includes the following embodiments.

Embodiment 1: An electrochemical cell, comprising:
at least two first electrodes,
a separator layer,
a common second electrode,
an ionically conductive electrolyte,
a base, and
a lid,
wherein the common second electrode is embedded in the base and the at least two first electrodes are embedded in the lid,
wherein the separator layer is an ionically conductive, electrically isolating separator layer that separates the at least two first electrodes from the common second electrode,
wherein the ionically conductive electrolyte creates an ionic pathway between the at least two first electrodes and the common second electrode,
wherein the separator layer can comprise the ionically conductive electrolyte,
wherein the base and lid are sealed against each other with an O-ring,
wherein the O-ring is made of an elastomer which is chemically compatible with the electrolyte,
wherein the at least two first electrodes can be used for constant-current and constant-voltage cycling of a corresponding number of cells, wherein each of the cells comprises one of the at least two first electrodes, the separator layer, the ionically conductive electrolyte, and the common second electrode,
wherein each first electrode is sealed against the lid by a chemically compatible elastomer O-ring,
wherein at least one first electrode is electrically independent from all other first electrodes, and
wherein the lid has at least one hole, wherein the at least one hole can have at least one first electrode that is part of at least one cell.

Embodiment 2: The electrochemical cell according to Embodiment 1, wherein each first electrode is electrically independent from all other first electrodes.

Embodiment 3: The electrochemical cell according to Embodiment 1, wherein each first electrode is a working electrode and the common second electrode is a reference electrode.

Embodiment 4: The electrochemical cell according to Embodiment 2, wherein each first electrode is a working electrode and the common second electrode is a reference electrode.

Embodiment 5: The electrochemical cell according to Embodiment 1, wherein each of the first electrodes and the common second electrode is a metal contact for testing an electrolyte.

Embodiment 6: The electrochemical cell according to Embodiment 1, wherein the base comprises PEEK, PTFE, or stainless steel.

Embodiment 7: The electrochemical cell according to Embodiment 1, wherein

the cells are half cells.

Embodiment 8: The electrochemical cell according to Embodiment 1, wherein the common reference electrode comprises a single piece of lithium film, lithium foil, or lithium sheet.

Embodiment 9: The electrochemical cell according to Embodiment 1, wherein the common reference electrode comprises a single piece of metal film, metal foil, or metal sheet, wherein the metal is an alkali metal other than lithium.

Embodiment 10: The electrochemical cell according to Embodiment 1, wherein the separator layer comprises a polymer separator.

Embodiment 11: The electrochemical cell according to Embodiment 1, wherein the separator layer comprises a solid electrolyte.

Embodiment 12: The electrochemical cell according to Embodiment 1, wherein the separator layer comprises a gel electrolyte.

Embodiment 13: The electrochemical cell according to Embodiment 1, wherein the ionically conductive electrolyte is a liquid electrolyte.

Embodiment 14: The electrochemical cell according to Embodiment 1, wherein the lid has an array of holes, wherein each hole can have one first electrode that is part of one cell.

Embodiment 15: The electrochemical cell according to Embodiment 1, further comprising a mechanical clamp to provide stack pressure within the electrochemical cell.

Embodiment 16: The electrochemical cell according to Embodiment 1, wherein each first electrode is a working electrode and the common second electrode is a common reference electrode, each working electrode is electrically independent from all other working electrodes, the common reference electrode comprises a single piece of lithium film, lithium foil, or lithium sheet, and the lid has an array of holes, each hole having one working electrode that is part of one half cell.

Embodiment 17: A method for preparing an electrochemical cell, comprising:
adding a cathode powder and a pre-dispersion solution to a syringe,
placing the syringe in a planetary centrifugal mixer,
mixing the cathode powder and the pre-dispersion solution in the syringe in the planetary centrifugal mixer to provide a resulting mixture,
dispensing the resulting mixture (a slurry) from the syringe onto aluminum SEM stubs to provide working electrodes in the lid assembly, and
placing the lid assembly containing the working electrodes on a base containing a common reference electrode having a separator layer thereon, such that the working electrodes contact the separator layer, thereby preparing the electrochemical cell.

Embodiment 18: The method according to Embodiment 17, further comprising mechanically clamping the lid assembly to the base to provide stack pressure within the electrochemical cell.

Embodiment 19: The method according to Embodiment 17, wherein a solvent to aid mixing is added to the syringe in addition to the cathode powder and the pre-dispersion solution.

Embodiment 20: The method according to Embodiment 17, wherein the pre-dispersion solution comprises PVDF, NMP, and carbon.

Embodiment 21: The method according to Embodiment 17, wherein the stubs are pre-assembled in the lid prior to dispensing the slurry.

Embodiment 22: The method according to Embodiment 17, wherein the stubs are prepared with the slurry and then assembled in the lid.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Example embodiments of the present disclosure will be more clearly understood from the following detailed description taken in conjunction with the accompanying drawings in which:

FIG. 1 is a diagram showing a multi-electrode, high-throughput electrochemical cell of the present disclosure.

FIG. 2 is an illustration showing a high-throughput cell design of the present disclosure.

FIG. 3 is an illustration showing the preparation of a high-throughput cell of the present disclosure.

FIG. 4 is a graph showing voltage vs. specific capacity for an example embodiment of the present disclosure.

FIG. 5 is a graph showing voltage vs. cycle number for an example embodiment of the present disclosure.

FIG. 6 is a graph showing specific capacity vs. cycle number for an example embodiment of the present disclosure.

FIG. 7 is a diagram showing another multi-electrode, high-throughput electrochemical cell of the present disclosure.

### DETAILED DESCRIPTION OF EXAMPLE EMBODIMENTS

The embodiments of the disclosure described herein are example embodiments, and thus, the disclosure is not limited thereto, and may be realized in various other forms. Each of the embodiments provided in the following description is not excluded from being associated with one or more features of another example or another embodiment also provided herein or not provided herein but consistent with the disclosure. For example, even if matters described in a specific example or embodiment are not described in a different example or embodiment thereto, the matters may be understood as being related to or combined with the different example or embodiment, unless otherwise mentioned in descriptions thereof. In addition, it should be understood that all descriptions of principles, aspects, examples, and embodiments of the disclosure are intended to encompass structural and functional equivalents thereof. In addition, these equivalents should be understood as including not only currently well-known equivalents but also equivalents to be developed in the future.

As used herein, expressions such as “at least one of,” when preceding a list of elements, modify the entire list of elements and do not modify the individual elements of the list. For example, the expression, “at least one of a, b and c,” should be understood as including only a, only b, only c, both a and b, both a and c, both b and c, or all of a, b and c.

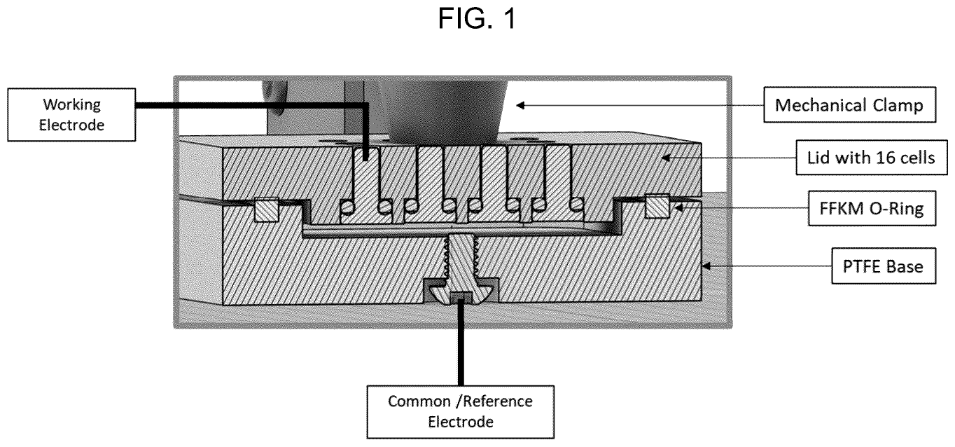

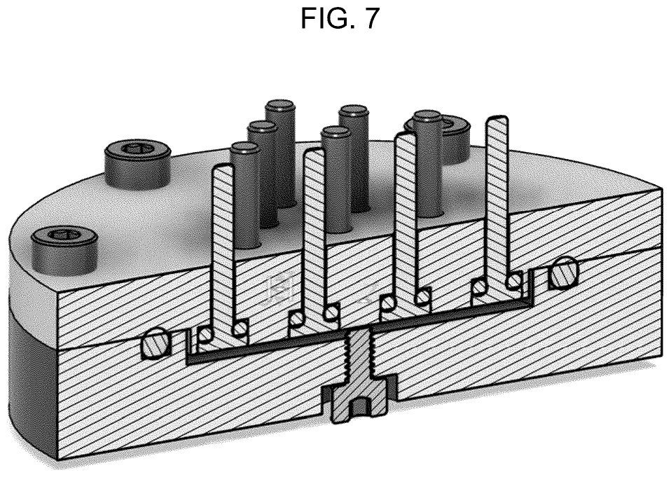

The present disclosure provides an electrochemical cell which according to some embodiments can utilize electrically independent electrodes, allowing it to perform constant-current (CC) and constant-voltage (CV) cycling of half cells. As illustrated in FIG. 1, multiple working electrodes may be arranged in an array, chemically compatible o-rings provide sealing and mechanical pressure to the working electrodes, and a mechanical clamp provides static pressure to the lid and a single, fixed motion for sealing and unsealing the cell. As an alternative to using a mechanical clamp, static pressure can be provided to the lid by, e.g., bolts as shown in FIG. 7.

As a result of independent channels, the data generated from these tests can be more closely aligned with battery testing protocols. Furthermore, because channels are electrically independent of each other, other battery testing techniques such as Rate capability, Power curves, DCIR, ACIR and EIS can be performed without physically perturbing the cell.

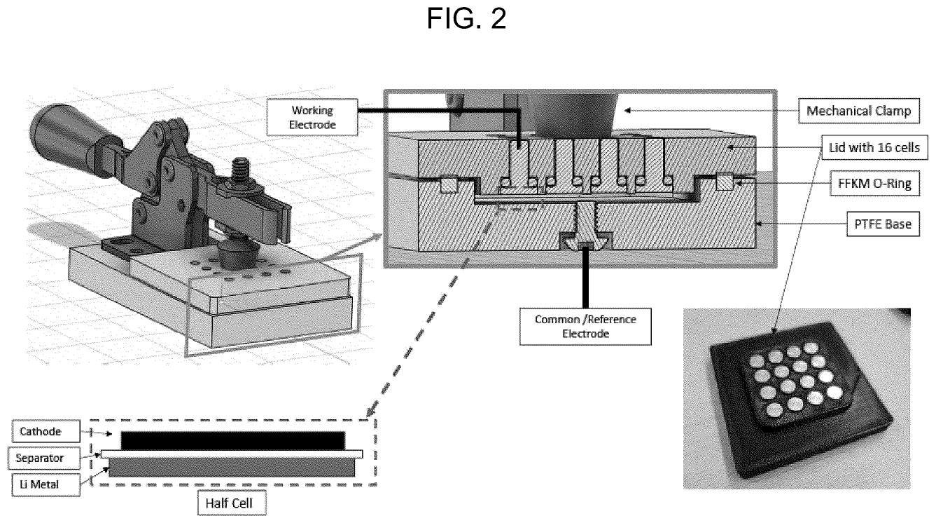

In greater detail with reference to FIG. 1 showing an embodiment of the present disclosure, the lid assembly (in blue) is preassembled in advance with any number of working electrodes. For example, as shown in FIG. 2, there are 16 working electrodes according to some embodiments. Once a cathode/anode slurry is prepared, it may be dispensed onto each individual electrode (orange) via a pipette, syringe or slurry casting method. This creates consistency in the composition and mass loadings per half cell. Each electrode may be sealed against the lid by a small O-ring (pink) which doubles as a spring to apply pressure to the working electrode. The lid with slurry may be dried in an oven and statically pressed to improve wettability and electrical conductivity. It may then be transferred to a glove box for assembly with the rest of the cell. The “base” of the cell (pink) is made of PTFE or other compatible material (e.g., PEEK, stainless steel) with a single piece of lithium foil to act as a common reference electrode, which is punched from a die. The lithium foil may be laid into the base, followed by a polymer separator or other electrically insulating material that provides ionic conductivity (e.g., gel or solid electrolyte, catholyte, anolyte). Electrolyte may be added and the lid assembly with dried cathode/anode slurry is placed on top and mechanically clamped to provide stack pressure within the cell. Electrical leads are connected to each individual electrode on the lid; the lithium foil is connected via a common electrode. The electrical leads connect to a battery multi-channel cycler (such as an Arbin, Maccor, Neware, or Solartron cycler) for testing.

Some embodiments may include, for example, testing of cathode materials vs. Li metal, testing of anode materials vs. Li metal, testing of cathode materials vs. anode materials, testing electrolytes, performing combinatorial studies by varying the slurry preparation and deposition methods, varying the number of electrodes to optimize for mass loadings, cell geometry, yield, etc. To further increase throughput, the electrochemical cell of the present disclosure can be integrated with an automated synthesis tool to provide additional consistency in half cells or create well-ordered variations in composition for combinatorial studies. The automated synthesis tool can also be used to automate the materials synthesis and slurry preparation and dispensing.

In an embodiment of the present disclosure a slurry can be mixed inside a plastic syringe.

For example, in a method of the present disclosure, a cathode powder can be dispensed into a syringe, a pre-dispersion (PVDF+carbon+NMP) solution can be added, additional solvent can be added to aid mixing, the syringe can be placed in a planetary centrifugal mixer such as a THINKY mixer to mix the cathode powder, pre-dispersion solution and any additional solvent, and the resulting mixture can be dispensed onto a current collector such as an aluminum SEM stub which can be assembled into a cell (coin cell or HT cell). As another example of a pre-dispersion solution, CMC+carbon+water can be used. The additional solvent can be the same solvent as that used in the pre-dispersion solution, such as NMP or water. Further, a cycling test of the cell can be conducted with a cycler such as a Neware cycler or an Arbin cycler.

### EXAMPLE

Embodiments will now be illustrated by way of the following example, which does not limit the embodiments in any way.

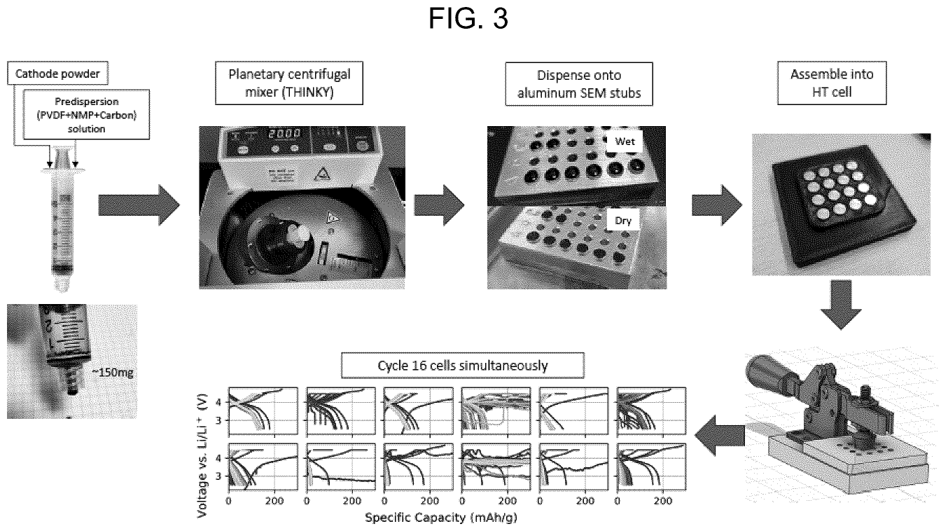

FIG. 3 shows the preparation and testing of a high-throughput (HT) electrochemical cell, in which a cathode powder and a pre-dispersion (PVDF+NMP+carbon) solution were added to a syringe, the syringe was placed in a THINKY planetary centrifugal mixer to mix the cathode powder and pre-dispersion solution, the resulting mixture was dispensed onto aluminum SEM stubs which were assembled into a high-throughput electrochemical cell including 16 half cells, and the 16 half cells were cycled simultaneously in a cycling test to provide results such as voltage vs. specific capacity (FIG. 3 shows the voltage vs. specific capacity results for 12 out of the 16 half cells).

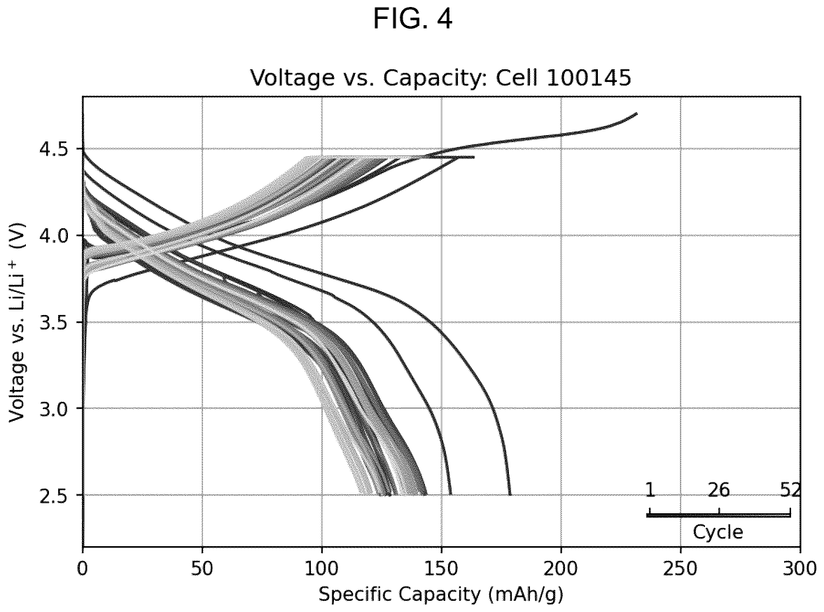

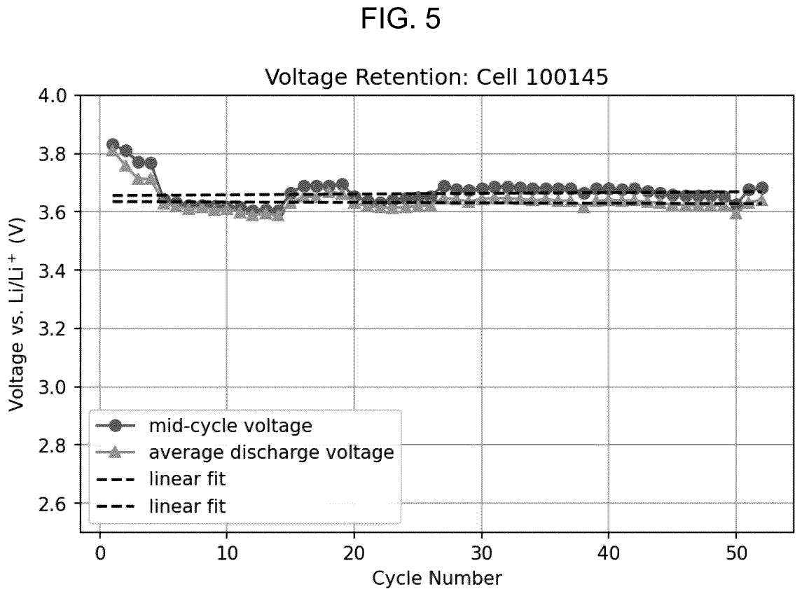

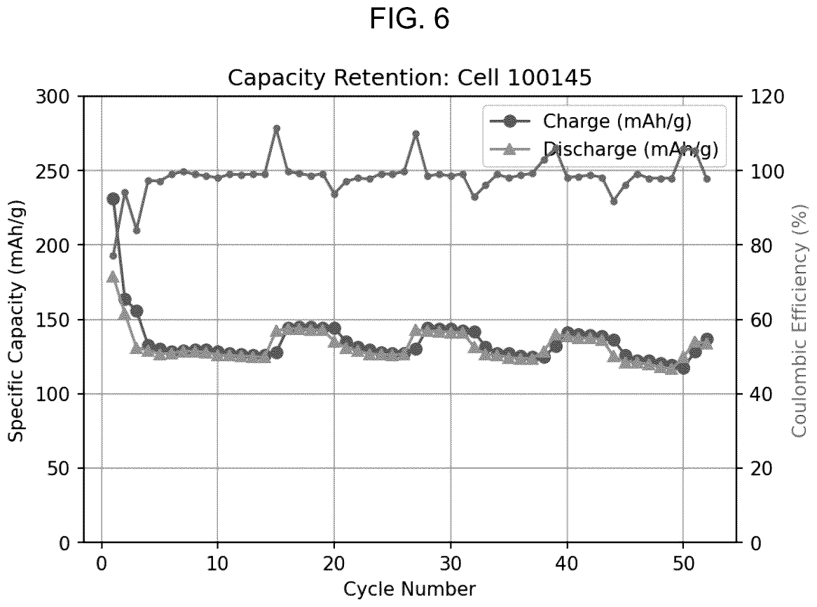

The results for one particular half cell (Cell 100145) in an example embodiment of the present disclosure are shown in FIGS. 4-6. In particular, FIG. 4 is a graph showing voltage vs. specific capacity for Cell 100145, FIG. 5 is a graph showing voltage vs. cycle number for Cell 100145, and FIG. 6 is a graph showing specific capacity vs. cycle number for Cell 100145. The results show the excellent performance provided by an embodiment of the present disclosure.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. An electrochemical cell, comprising:
at least two first electrodes,
a separator layer,
a common second electrode,
an ionically conductive electrolyte,
a base, and
a lid,
wherein the common second electrode is embedded in the base and the at least two first electrodes are embedded in the lid,
wherein the separator layer is an ionically conductive, electrically isolating separator layer that separates the at least two first electrodes from the common second electrode,
wherein the ionically conductive electrolyte creates an ionic pathway between the at least two first electrodes and the common second electrode,
wherein the separator layer can comprise the ionically conductive electrolyte,
wherein the base and lid are sealed against each other with an O-ring,
wherein the O-ring is made of an elastomer which is chemically compatible with the electrolyte,
wherein the at least two first electrodes can be used for constant-current and constant-voltage cycling of a corresponding number of cells, wherein each of the cells comprises one of the at least two first electrodes, the separator layer, the ionically conductive electrolyte, and the common second electrode,
wherein each first electrode is sealed against the lid by a chemically compatible elastomer O-ring,
wherein at least one first electrode is electrically independent from all other first electrodes, and
wherein the lid has at least one hole, wherein the at least one hole can have at least one first electrode that is part of at least one cell.

2. The electrochemical cell according to claim 1, wherein each first electrode is electrically independent from all other first electrodes.

3. The electrochemical cell according to claim 1, wherein each first electrode is a working electrode and the common second electrode is a reference electrode.

4. The electrochemical cell according to claim 2, wherein each first electrode is a working electrode and the common second electrode is a reference electrode.

5. The electrochemical cell according to claim 1, wherein each of the first electrodes and the common second electrode is a metal contact for testing an electrolyte.

6. The electrochemical cell according to claim 1, wherein the base comprises PEEK, PTFE, or stainless steel.

7. The electrochemical cell according to claim 1, wherein the cells are half cells.

8. The electrochemical cell according to claim 1, wherein the common reference electrode comprises a single piece of lithium film, lithium foil, or lithium sheet.

9. The electrochemical cell according to claim 1, wherein the common reference electrode comprises a single piece of metal film, metal foil, or metal sheet, wherein the metal is an alkali metal other than lithium.

10. The electrochemical cell according to claim 1, wherein the separator layer comprises a polymer separator.

11. The electrochemical cell according to claim 1, wherein the separator layer comprises a solid electrolyte.

12. The electrochemical cell according to claim 1, wherein the separator layer comprises a gel electrolyte.

13. The electrochemical cell according to claim 1, wherein the ionically conductive electrolyte is a liquid electrolyte.

14. The electrochemical cell according to claim 1, wherein the lid has an array of holes, wherein each hole can have one first electrode that is part of one cell.

15. The electrochemical cell according to claim 1, further comprising a mechanical clamp to provide stack pressure within the electrochemical cell.

16. The electrochemical cell according to claim 1, wherein each first electrode is a working electrode and the common second electrode is a common reference electrode, each working electrode is electrically independent from all other working electrodes, the common reference electrode comprises a single piece of lithium film, lithium foil, or lithium sheet, and the lid has an array of holes, each hole having one working electrode that is part of one half cell.

17. A method for preparing an electrochemical cell, comprising:
adding a cathode powder and a pre-dispersion solution to a syringe,
placing the syringe in a planetary centrifugal mixer,
mixing the cathode powder and the pre-dispersion solution in the syringe in the planetary centrifugal mixer to provide a resulting mixture,
dispensing the resulting mixture from the syringe onto aluminum SEM stubs to provide working electrodes in the lid assembly, and
placing the lid assembly containing the working electrodes on a base containing a common reference electrode having a separator layer thereon, such that the working electrodes contact the separator layer, thereby preparing the electrochemical cell.

18. The method according to claim 17, further comprising mechanically clamping the lid assembly to the base to provide stack pressure within the electrochemical cell.

19. The method according to claim 17, wherein a solvent to aid mixing is added to the syringe in addition to the cathode powder and the pre-dispersion solution.

20. The method according to claim 17, wherein the pre-dispersion solution comprises PVDF, NMP, and carbon.
